(19) United States
(12) Patent Application Publication
(10) Pub. No.: US 2014/0266801 A1
(43) Pub. Date: Sep. 18, 2014

(54) Digital Parking Management, Enforcement, and Notification

(71) Applicant: INFINITE COMPUTING SYSTEMS, INC., Cedar Rapids, IA (US)

(72) Inventors: Kunal UPPAL, Cedar Rapids, IA (US); Richard Barchard, Cedar Rapids, IA (US); Brad Russell, Cedar Rapids, IA (US); Rajendra Inani, Cedar Rapids, IA (US)

(73) Assignee: Infinite Computing Systems, Inc., Cedar Rapids, IA (US)

(21) Appl. No.: 13/827,742

(22) Filed: Mar. 14, 2013

(51) Int. Cl. G08G 1/14

(52) U.S. Cl. CPC G08G 1/144
USPC 340/932.2

(57) ABSTRACT

Systems, methods, and computer program products for digital parking management, enforcement, and notification are provided. In one embodiment, a parking operations system is provided. The parking operations system is configured to receive parking vendor data from a plurality of parking meter vendors, process the received parking vendor data to generate aggregated parking data, receive a request for parking data from a parking operator, and send the requested parking data and associated views for displaying the parking data to the parking operator. In another embodiment, the parking operations system is configured to receive a parking location request from an application and to send probable parking locations, in response to the parking location request, to the application.

### BACKGROUND

1. Field of the Invention

The present disclosure relates generally to digital parking management, enforcement, and notification.

2. Background Art

Recently, there has been a significant growth in digital parking meter vendor services. Typically, however, real time data associated with such services is spread across disparate platforms, which substantially increases the human/automated resources needed for parking management and enforcement.

### BRIEF DESCRIPTION OF THE DRAWINGS/FIGURES

The accompanying drawings, which are incorporated herein and form a part of the specification, illustrate the present disclosure and, together with the description, further serve to explain the principles of the disclosure and to enable a person skilled in the pertinent art to make and use the disclosure.

FIG. 1 illustrates an example digital parking system according to an embodiment.

FIG. 2 illustrates an example parking operations system according to an embodiment.

FIG. 3 illustrates another example digital parking system according to an embodiment.

FIG. 4 is an example snapshot of a parking management system according to an embodiment.

FIG. 5 is another example snapshot of a parking management system according to an embodiment.

FIG. 6 illustrates an example application layer stack implementation for a parking operations system according to an embodiment.

FIG. 7 is an example process for facilitating parking management according to an embodiment.

FIG. 8 is an example process for facilitating locating parking space according to an embodiment.

FIG. 9 is an example process for facilitating parking enforcement according to an embodiment.

FIG. 10 illustrates an example computer system that can be used to implement aspects of embodiments.

The present disclosure will be described with reference to the accompanying drawings. Generally, the drawing in which an element first appears is typically indicated by the leftmost digit(s) in the corresponding reference number.

### DETAILED DESCRIPTION OF EMBODIMENTS

For purposes of this discussion, the term “module” shall be understood to include at least one of software, firmware, and hardware (such as one or more circuits, microchips, or devices, or any combination thereof), and any combination thereof. In addition, it will be understood that each module can include one, or more than one, component within an actual device, and that each component that forms a part of the described module can function either cooperatively or independently of any other component forming a part of the module. Conversely, multiple modules described herein can represent a single component within an actual device. Further, components within a module can be in a single device or distributed among multiple devices in a wired or wireless manner.

FIG. 1 illustrates an example digital parking system. 100 according to an embodiment. As shown in FIG. 1, digital parking system 100 includes a parking operations system 102, a plurality of digital parking stations 104-1 and 104-2, a wireless access network 106, a plurality of parking meter vendor services 108-1 and 108-2, a parking management system 110, a street ambassador mobile application 112, a parking locating mobile application 114, a third party server 116, a parking management service 118, a License Plate Recognition (LPR) device 120, and an advertisement service 122.

As would be understood by a person of skill in the art based on the teachings herein, embodiments are not limited by example digital parking system 100. For example, for the purpose of illustration only, example digital parking system 100 is shown to include a single parking operations system 102, two digital parking stations 104, two parking meter vendor services 108, a single parking management system 110, a single street ambassador mobile application 112, a single parking locating mobile application 114, a single third party server 116, a single parking management service 118, and a single LPR device 120. However, in other embodiments, digital parking system 100 can include any number (including none) of each of these systems and/or applications. Further, in other embodiments, digital parking system 100 can include additional components, not shown in FIG. 1, but which will be apparent to a person of skill in the art based on the teachings herein.

In example digital parking system 100, digital parking stations 104-1 and 104-2 are each associated with a respective parking lot or garage. In another embodiment, digital parking stations 104-1 and 104-2 may be associated with the same parking lot or garage. The parking lot or garage can include one or more parking stalls, each designed for parking a single vehicle. In an embodiment, each parking stall is identified with a visible number, typically indicated on the parking stall surface or a nearby sign.

Typically, digital parking stations 104-1 and 104-2 are located in close proximity to the parking lot or garage with which they are associated. In an embodiment, a person wishing to park his/her vehicle in the parking lot parks in a given parking stall, notes down the parking stall number, and then performs a payment transaction at a digital parking station 104 by entering the parking stall number, entering a desired parking duration, and submitting payment (e.g., cash, credit/debit card, etc.) for the desired parking duration. Digital parking station 104 verifies the submitted payment, and if the payment is verified successfully, prints a payment receipt, which may indicate, among other things, a transaction time, a parking expiration time, and the parking stall number, for example.

Generally, digital parking stations 104-1 and 104-2 are each associated with a respective parking meter vendor service 108, which is responsible for managing the digital parking station 104. For example, digital parking stations 104-1 and 104-2 are associated respectively with parking meter vendor services 1084 and 108-2. In general, a parking meter vendor service 108 can manage a plurality of digital parking stations 104, located at various parking lots or garages. Typically, a parking meter vendor service 108 is hosted by one or more servers, which may provide one or more Application Programming Interfaces (APIs), one or more applications, and web services.

In an embodiment, digital parking station 104-1 can communicate with parking meter vendor service 1084 using a wireless access network 106. In an embodiment, wireless access network 106 includes a plurality of wireless access points (APs), distributed over a geographic area, configured to receive communication wirelessly from digital parking station 104-1 and to convey the communication either wirelessly or through wired means to parking meter vendor service 108-1. Conversely, wireless access network 106 is configured to receive communication either wirelessly or through wired means from parking meter vendor service 108-1 and to convey the communication wirelessly to digital parking station 104-1.

In another embodiment, wireless access network 106 (or another network) can support communication between digital parking stations 104 and/or digital parking/garage entry/exit stations (not shown in FIG. 1) and a parking management service 118. Specifically, parking management service 118 can collect specific data from digital parking stations 104 and/or the digital parking/garage entry/exit stations to generate management related statistics, such as occupancy statistics, time of day statistics, etc.

According to embodiments, communication from digital parking station. 104-1 to parking meter vendor service 108-1 can include requests for credit/debit card payment verification, parking station health information, and parking stall information. Communication from parking meter vendor service. 108-1 to digital parking station 104-1 can include credit/debit card payment verification results and control/configuration information.

Generally, requests for credit/debit card payment verification are sent in real time by digital parking station 104-1 to parking meter vendor service 108-1, and typically include a credit/debit card number, a card expiration date, and optionally a card security code. Parking station health information includes information regarding an operational status/health of the digital parking station (e.g., online/offline, error state/type of error, battery level, if applicable, printer paper level, printer ink level, local time, etc.). Parking station health information can be sent periodically from digital parking station 104-1 to parking meter vendor service 108-1 at configurable intervals. Parking stall information includes information regarding the status of one or more parking stalls in the parking lot or garage with which digital parking station 104-1 is associated. In an embodiment, parking stall information is sent in real time upon the reservation of a parking stall through payment. The parking stall information can include a parking stall number, a transaction time, a parking expiration time of the parking stall, and an identifier of the digital parking station used to reserve the parking stall. In another embodiment, parking stall information is sent as a batch containing information for multiple parking stalls. In an embodiment, no additional hardware such as parking stall sensors to detect the presence or absence of vehicles in parking stalls is needed.

Parking meter vendor services 108-1 and 108-2 each receives parking station health information and parking stall information from one or more digital parking stations 104 that they manage. The received parking station health information and parking stall information are processed and then stored as or used to update parking station health data and parking stall data respectively in one or more databases of the parking meter vendor service 108. In an embodiment, parking meter vendor service 108 augments the received parking station health information and the parking stall information with additional parking information, such as parking rates, parking hours, maximum parking time, and enforcement hours to generate the parking station health data and the parking stall data.

Parking operations System 102 is configured to receive (periodically or on-demand) vendor data from a plurality of parking meter vendors, such as parking meter vendor services 108-1 and 108-2. The vendor data from a parking meter vendor can include some or all of the parking station health data, some or all of the parking stall data, and some or all of the additional parking information available in the one or more databases of the parking meter vendor. For example, in an embodiment, the entirety of the parking station health data and parking stall data is received initially from the parking meter vendor and only modification updates are subsequently received, in an embodiment, parking operations system 102 accesses the parking station health data and parking stall data of a particular parking meter vendor using an Open API, provided by the parking meter vendor, which provides programmatic access to the one or more databases of the parking meter vendor.

In an embodiment, the storage and/or formatting of the parking station health data and the parking stall data varies from one parking meter vendor to another. Accordingly, as described further below, parking operations system 102 implements a plurality of data extraction and transformation modules each tailored for a particular parking meter vendor to extract the parking station health data and the parking stall data from the parking meter vendor and to transform the extracted data into a common format.

Parking operations system 102 is configured to aggregate the vendor data from the plurality of parking meter vendors, such as parking meter vendor services 1084 and 108-2, to generate aggregated parking data. Specifically, parking operations system 102 is configured to process the parking station health data from the plurality of parking meter vendors to generate aggregated parking station health data, and to process the parking stall data from the plurality of parking meter vendors to generate aggregated parking stall data. The aggregated parking station health data includes the health data of a plurality of digital parking stations, which may be located in various parking lots/garages and/or managed by various parking meter vendors. The aggregated parking stall data includes parking stall data for a plurality of parking stalls, which may be distributed across various parking lots/garages and/or managed by various parking meter vendors.

In an embodiment, parking operations system 102 can modify the parking station health data and/or the parking stall data according to predetermined configurable business rules. The business rules may be selected to accommodate specific functions requested by parking management system 110. For example, the parking station health data of a particular vendor may include a critical status alert when a parking station battery falls below a critical battery level. This critical battery level may be different from one vendor to another. To provide uniformity across vendor data, in an embodiment, parking operation system 102 modifies (overrides) vendor specific parking station health data and/or parking stall data to set them according to predetermined custom rules. For example, the critical battery level can be customized across different vendors using a configurable rule.

Parking operations system 102 is further configured to support parking management system 110, which can be used by a parking operator to manage and enforce parking in one or more parking lots or garages managed by the parking operator. The parking operator can be a public (e.g., city or local authority) or a private (e.g., contractor) entity. In an embodiment, parking management system 110 includes a web interface for a cloud-based application, which enables the parking operator to receive and view parking data for the one or more parking lots or garages managed by the parking operator. In another embodiment, the web interface further enables the parking operator to track and to send messages to street ambassadors associated with the parking operator in order to facilitate parking enforcement of the one or more parking lots or garages managed by the parking operator. In an embodiment, messages sent by the parking operator are logged in parking operations system 102 (may be used to update the aggregated parking data if applicable) and then pushed to or downloaded by the street ambassadors using mobile applications, such as mobile application 112. In a further embodiment, street ambassadors can use mobile applications, such as mobile application 112, to send messages and/or time tracking data (e.g., time sheets) to the parking operator. In an embodiment, messages sent by the street ambassadors are logged in parking operations system 102 (may be used to update the aggregated parking data if applicable) and then forwarded to parking management system 110.

In an embodiment, mobile application 112 enables street ambassadors to monitor parking according to configurable business rules. For example, street ambassadors can use mobile application 112 to set a configurable timing rule for filtering expired parking stalls. The timing rule accepts a time duration and returns only those expired parking stalls that have been overdue for at least the time duration. This gives flexibility to street ambassadors to be selective based on time of the day and/or the geographic area they are in. For example, in certain areas, the street ambassador can set the time duration for 20 minutes, but in other busier areas can set the time duration for 5 minutes, for stricter enforcement.

In another embodiment, street ambassadors can be equipped with LPR devices, such as LPR device 120, configured to recognize license plates. In an embodiment, the LPR devices communicate with parking meter vendor services 108 to relay information, such as the license plates of vehicles parked at expired and/or unexpired parking stalls. Parking meter vendor services 108 can process this information along with other parking data received from digital parking stations 104 and provide this data to parking operations system 102. In another embodiment, alternatively or additionally, the LPR devices can send the same information directly to parking operations system 102, or interact with mobile applications, such as mobile application 112, which send the information to parking operations system 102. Parking operations system 102 can thus make license plate information additionally available to parking management system 110 for improved parking enforcement.

In an embodiment, parking operations system 102 is configured to receive a request for parking data from the parking operator via parking management system 110, to generate the requested parking data responsive to the request, and to send the requested parking data and associated views for displaying the parking data to the parking management system 100. In an embodiment, the request is generated as a result of the parking operator logging into the web interface and selecting a particular view of the parking data (for the one or more parking lots or garages managed by the parking operator) from the web interface. The parking data is generated responsive to the selected view and then sent to the parking data along with associated views for displaying the parking data at parking management system 110. In an embodiment, the parking data is generated by filtering the aggregated parking data, responsive to the parking data request. For example, the filtering can include filtering the aggregated parking data by parking operator (e.g., retrieving only data associated with the parking operator sending the request), by digital parking station (e.g., retrieving parking station health data for a particular digital parking station or to enable a selected view of parking data), by parking stall (e.g., retrieving parking stall data for a particular parking stall or to enable a selected view of parking data), etc.

In an embodiment, the parking data includes health data representative of an operational status of a plurality of digital parking stations managed by the parking operator, parking stall data representative of the status of a plurality of parking stalls managed by the parking operator, and street ambassador data representative of geographic availability of street ambassadors (e.g., parking attendants) associated with the parking operator. In an embodiment, the parking stall data further includes space availability data representative of available parking space in the one or more parking lots or garages managed by the parking operator. In an embodiment, the street ambassador data further provides Global Navigation Satellite System (GNSS) tracking data of the street ambassadors such that they can be located on a geospatial map. Additionally, the street ambassador data can also indicate which street ambassadors are on duty/off duty. In a further embodiment, the parking data can include historical health and/or parking stall data. The historical health data can be used to assess the general functioning of digital parking stations and/or to determine future maintenance needs of the digital parking stations, for example. The historical parking stall data can be used to assess the general use/occupancy of a particular parking lot or garage, and to generate business intelligence reports to forecast parking occupancy for a particular region or parking lot/garage, for example. For example, reports forecasting occupancy on regular days, holidays, inclement weather (e.g., snow, storm, etc.) days, event days, etc. can be generated using the historical parking stall data.

In an embodiment, the web interface of parking management system 110 includes a cloud-based dashboard. Example snapshots of such a dashboard are provided in FIGS. 4 and 5 for the purpose of illustration. As would be understood by a person of skill in the art based on the teachings herein, embodiments are not limited by these examples.

FIG. 4 is an example dashboard snapshot 400 that shows a particular view of parking data that can be selected by the parking operator. Specifically, the view shown by example snapshot 400 includes a street space availability listing 402, a notifications and alerts listing 404, a health and maintenance listing 406, a geospatial map 408, a message button 414, and a history button 416. Street space availability listing 402 includes a listing of digital parking stations managed by the parking operator, showing for each digital parking station the number of available parking stalls and the number of open parking stalls associated with the digital parking station. Notifications and alerts listing 404 provides real time notifications and alerts to the parking operator, including, for example, notifications regarding street ambassador availability (e.g., on duty, on break, etc.) and status alerts regarding digital parking stations. Health and maintenance listing 406 provides health data regarding digital parking stations managed by the parking operator. In addition, health and maintenance listing 406 provides information regarding the maintenance of digital parking stations, when applicable (e.g., street ambassador dispatched to fix a digital parking station reporting an error). Map 408 provides a geographic view (street view, map view, or satellite view) of an area based on a selected address or location. The view can include icons, such as icon 410, that correspond to the locations of digital parking stations managed by the parking operator, and icons, such as icon 412, that correspond to the locations of street ambassadors associated with the parking operator. Message button 414 can be clicked on to open a messaging window that can be used to send a message to a particular street ambassador. History button 416 can be clicked on to display additional history of notifications and alerts.

FIG. 5 is another example dashboard snapshot 500 that shows a particular view of parking data that can be selected by the parking operator. Like example snapshot 400, example snapshot 500 also includes a street space availability listing 402, a health and maintenance listing 406, and a map 408. Additionally, example snapshot 500 includes an expiring meters listing 502 that lists parking stalls (associated with the one or more digital parking stations managed by the parking operator) that are set to expire within a selected duration. In an embodiment, listing 502 groups the listed parking stalls by digital parking station, displaying for each digital parking station the numbers (or identifiers) of the parking stalls set to expire within the selected duration. In another embodiment, listing 502 can sort the expiring parking stalls in ascending/descending order of expiration time. In an embodiment, digital parking stations with expiring parking stalls within the selected duration are highlighted (e.g., in red) on map 408, enabling the parking operator to easily identify and dispatch street ambassadors located in proximity to these digital parking stations. In another embodiment, the selected duration is user configurable (e.g., can be selected from a number of options or can be entered manually), and its selection/re-selection causes listing 502 and map 408 to be updated.

Returning to FIG. 1, parking operations system 102 is further configured to support parking locating mobile application 114 (or other mobile/non-mobile applications), which can be used by a user to locate parking in an desired location. In an embodiment, mobile application 114 can be used to send a parking location request to parking operations system 102. In an embodiment, the parking location request can include an address, GNSS coordinates, the name of a place (e.g., Times Square), or any other location identifying information. Additionally, the parking location request can include parking preferences such as a desired maximum parking time, a desired parking rate, desired characteristics of the parking (e.g., open lot, gated lot, garage, etc.), and a maximum distance from the desired parking location. Parking operations system 102 is configured to process the aggregated parking data by applying logic that involves historical factors and probability, to generate and send probable parking locations to mobile application 114. The probable parking locations include parking options that match or substantially match the desired location and any provided parking preferences. In an embodiment, a probable parking location can include, for example, an address of the parking lot or garage, a number of currently open spaces in the parking lot or garage, an hourly parking rate, a maximum parking time, etc.

In an embodiment, parking operations system 102 is configured to determine a score for a parking lot/garage that indicates the probability that an open parking stall will be found in the parking lot/garage. If the score is above a certain threshold, then the parking lot/garage is included in the probable parking locations sent to mobile application 114. In an embodiment, to determine a score for a parking lot/garage, parking operations systems 102 is configured to (1) find a total expired count (n) based on the expiration time of all parking stalls associated with a digital parking station of the parking lot/garage: (2) compute a probable score by diving the total expired count (n) by a total maximum possible outcomes (n+1); (3) determine an average purchase time of all parking stalls from historical parking stall data (in an embodiment, parking stalls with purchase time less than 1 hour are given greater weight in the average purchase time calculation); and (4) combine a historical factor (e.g., based on historical occupancy at different times of the day, time of the year, etc.) with the probable score to yield an overall score for the digital parking station. The overall score represents the probability that an open parking stall will be found in the parking lot or garage associated with the digital parking station.

In another embodiment, parking operations system 102 is further configured to include location-based advertisements with the probable parking locations sent to mobile application 114. In an embodiment, parking operations system 102 receives location-based advertisements (e.g., offers, discounts, coupons, etc.) from advertisement service 122 and includes a location relevant advertisement with the probable parking locations sent to the user. The location relevant advertisement can be selected based on any one of the parking preferences included in the parking location request. For example, the desired maximum parking time can be used to select advertisements that are appropriate to the expected time that the user is going to send in the parking area.

Parking operations system 102 is further configured to support third party server 116 to allow third parties to integrate additional services and/or mobile applications, for example, with parking operations system 102. In an embodiment, parking operations system 102 is configured to provide a Representational State Transfer (REST) API, SOAP (Simple Object Access Protocol) API, and/or an Open API for enabling third party server 116 programmatic access to certain components of parking operations system 102.

FIG. 2 illustrates an example parking operations system 200 according to an embodiment. Example system 200 is provided for the purpose of illustration only and is not limiting of embodiments. Example system 200 can be an embodiment of parking operations system 102 described above in FIG. 1. As shown in FIG. 2, example system 200 includes a data extraction and transformation module 202, a web user interface module 204, and a database 206.

Data extraction and transformation module 202 is configured to receive parking vendor data 212 from a plurality of parking meter vendors, such as parking meter vendor services 108 described above in FIG. 1. In an embodiment, the parking vendor data from a particular parking meter vendor includes at least one of parking station health data and parking stall data. The parking station health data includes data regarding an operational status/health of digital parking stations (e.g., online/offline, error state/type of error, battery level, if applicable, printer paper level, printer ink level, local time, etc.) managed by the parking meter vendor. The parking stall data includes data regarding the status of one or more parking stalls managed by the parking meter vendor. In an embodiment, the parking stall data for a particular parking stall includes a parking stall number, one or more digital parking stations associated with the parking stall, and a parking expiration time of the parking stall. In another embodiment, the parking vendor data includes additional parking data provided by the parking meter vendor, such as parking rates, parking hours, maximum parking time, and enforcement hours associated with the digital parking stations (or more specifically the parking lots/garages) managed by the parking meter vendor.

Data extraction and transformation module 202 is configured to process the received parking vendor data to generate aggregated parking data and to store the aggregated parking data in database 206. Specifically, module 202 is configured to process the parking station health data from the plurality of parking meter vendors to generate aggregated parking station health data, and to process the parking stall data from the plurality of parking meter vendors to generate aggregated parking stall data. The aggregated parking station health data includes the health data of a plurality of digital parking stations, which may be located in various parking lots/garages and/or managed by various parking meter vendors. The aggregated parking stall data includes parking stall data for a plurality of parking stalls, which may be distributed across various parking lots/garages and/or managed by various parking meter vendors.

Web user interface module 204 includes a controller module 208 and a view loading module 210. Together, controller module 208 and view loading module 210 enable a cloud-based application, which can be used by a parking operator as described above. Additionally, controller module 208 can support a variety of mobile applications, such as applications 112 and 114 described above.

In an embodiment, web user interface module 204 is configured to receive a request for parking data from a parking operator (e.g., via a parking management system 110) and to send the requested parking data and associated views for displaying the parking data to the parking operator. Specifically, controller module 208 is configured to receive the request for parking data from the parking operator, generate the requested parking data by accessing database 206, and send the requested parking data to the parking operator. Additionally, controller module 208 is configured, in an embodiment, to command view loading module 210 to generate the associated views necessary for displaying the requested parking data and to send the associated views to the parking operator.

In an embodiment, the request for parking data includes a parking information request for one or more digital parking stations and associated parking stalls managed by the parking operator, including, for example, space availability data, parking station health data, parking station maintenance data, expired parking data, and historical data associated with the one or more digital parking stations. In another embodiment, the request for parking data is generated as a result of the parking operator logging into a web interface (e.g., via parking management system 110) and selecting a particular view of the parking data (for the one or more parking lots or garages managed by the parking operator) from the web interface. For example, the request can be generated as a result of the parking operator selecting a view such as shown by example snapshots 400 and 500 described above. As such, the request includes information that can be used by controller module 208 to generate the parking data for the selected view.

In another embodiment, controller module 208 is configured to receive messages to street ambassadors from the parking operator and to log the messages in database 206. Controller module 208 is further configured to receive connection requests from the street ambassadors (e.g., via mobile application 112), in response to which controller module 208 pushes any messages stored in database 206 to the street ambassadors. Additionally, controller module 208 is configured to receive messages, GNSS tracking information, and time tracking information from the street ambassadors; store the messages, GNSS tracking information, and time tracking information in database 206; and then push the messages, GNSS tracking information, and time tracking information to the parking operator.

In another embodiment, controller module 208 is configured to receive a parking location request from a parking locating application (e.g., mobile application 114) as described above. Controller module 208 is configured to process the aggregated parking data available in database 206 to generate and send probable parking locations in response to the parking location request.

FIG. 3 illustrates another example digital parking system 300 according to an embodiment. Example system 300 is provided for the purpose of illustration only and is not limiting of embodiments. Example system 300 can be an embodiment of digital parking system 100 described above in FIG. 1. As shown in FIG. 2, example system 300 includes a plurality of parking meter vendors services 108-1, . . . , 108-n, a parking management system 110, a mobile application 114, and a parking operations system 200. Parking operations system 200 includes a data extraction and transformation module 202, a web user interface module 204, and a database 206.

As shown in FIG. 3, data extraction and transformation module 202 includes a plurality of virtual machines 302-1, . . . , 302-n. In an embodiment, each of virtual machines 302-1, . . . , 302-n is dedicated for a particular parking meter vendor service 108 in order to receive parking vendor data from the parking meter vendor service 108, transform the parking vendor data into a common format, and store the transformed parking vendor data in a real time database 304 of database 206. In an embodiment, at least one virtual machines 302 is configured to access the respective parking meter vendor service 108 using an Open API provided by the parking meter vendor service 108. In another embodiment, at least one of virtual machines 302 is implemented using a worker role module, such as a Windows® Azure worker role.

Database 206 includes a real time database 304 and an archives database 306. Real time database 304 is used for storing vendor parking data from data extraction and transformation module 202 and for access and/or modification by web user interface module 204 to respond to parking data requests from parking management system 110 and/or mobile application 114. Periodically (e.g., hourly, daily, etc.), real time database 304 is archived into archives database 306 to generate different time images of database 304.

Web user interface module 204 includes a web role module 308 (e.g., a Windows® Azure web role), a REST enabled API 310, and a Views module 312 (e.g., implemented using Microsoft® .NET MVC 4). REST enabled API 310 is configured to communicate with the parking operator (e.g., via parking management system 110) to receive a request for parking data and to send the requested parking data to the parking operator. In response to a request for parking data, web role module 308 is configured to access database 304, generate the parking data from the aggregated parking data stored in database 304, and command Views module 312 to generate and send the associated views for displaying the parking data to the parking operator. Additionally, REST enabled API 310 and web role module 308 can handle connection requests from mobile applications, such as mobile applications 112 and 114; receipt and delivery of messages, GNSS tracking information, and time tracking information from street ambassadors; receipt and delivery of messages from the parking operator to street ambassadors; and receipt and response to parking location requests from applications, such as mobile application 114.

FIG. 6 illustrates an example application layer stack implementation 600 for a parking operations system according to an embodiment. Example implementation 600 can be used for parking operations system 102, for example. Example implementation 600 is provided for the purpose of illustration only and is not limiting of embodiments.

As shown in FIG. 6, example implementation 600 includes a Web Dashboard module 602 (e.g., implemented using Microsoft® .NET MVC 4.0), which includes a views module 616 and a plurality of controller modules 618, for enabling a cloud-based application at the parking operator (e.g., via parking management system 110). Web Dashboard module 602 uses a Web API Layer 606 (e.g., implemented using .NET MVC 4.0 Web API) to handle requests for parking data from the parking operator. Web Dashboard module 602 in turn relies on data extraction and transformation library 608 to access a database 612. In an embodiment, database 612 is implemented as a Microsoft® SQL Server 2008, and is controlled using an Object-Relational Mapping (ORM) Layer 610 (e.g., Microsoft® Dapper). Data extraction and transformation library 608 uses a service proxy 614 for parking meter vendor APIs, to access parking meter vendor services. Additionally, a mobile/tablet application module 604 is provided for handling mobile applications. Module 604 includes a GNSS module 620 and a messaging module 622.

FIG. 7 is an example process 700 for facilitating parking management according to an embodiment. Example process 700 is provided for the purpose of illustration only and is not limiting of embodiments. Example process 700 can be performed by parking operations system 102, for example, to enable a cloud-based parking management system, such as parking management system 110.

As shown in FIG. 7, example process 700 begins in step 702, which includes receiving parking vendor data from a plurality of parking meter vendors. In an embodiment, the parking vendor data includes at least one of parking station health data and parking stall data. The parking station health data includes data regarding an operational status/health of digital parking stations (e.g., online/offline, error state/type of error, battery level, if applicable, printer paper level, printer ink level, local time, etc.) managed by the parking meter vendor. The parking stall data includes data regarding the status of one or more parking stalls managed by the parking meter vendor. In an embodiment, the parking stall data for a particular parking stall includes a parking stall number, one or more digital parking stations associated with the parking stall, and a parking expiration time of the parking stall. In another embodiment, the parking vendor data includes additional parking data provided by the parking meter vendor, such as parking rates, parking hours, maximum parking time, and enforcement hours associated with the digital parking stations (or more specifically the parking lots/garages) managed by the parking meter vendor. In an embodiment, at least one of the plurality of parking meter vendors provides an Open API, and step 702 further includes accessing, using the Open API, a service of the parking meter vendor to receive the parking vendor data.

Subsequently, example process 700 proceeds to step 704, which includes processing the received parking vendor data to generate aggregated parking data. In an embodiment, step 702 further includes processing the parking station health data to generate aggregated parking station health data representative of an operational status of a plurality of digital parking stations; and processing the parking stall data to generate aggregated parking stall data representative of the status of a plurality of parking stalls. The aggregated parking station health data includes the health data of a plurality of digital parking stations, which may be located in various parking lots/garages and/or managed by various parking meter vendors. The aggregated parking stall data includes parking stall for a plurality of parking stalls, which may be distributed across various parking lots/garages and/or managed by various parking meter vendors.

Then, in step 706, example process 700 includes receiving a request for parking data from a parking operator. In an embodiment, the request for parking data includes a parking information request for one or more digital parking stations and associated parking stalls managed by the parking operator, including, for example, space availability data, parking station health data, parking station maintenance data, expired parking data, and historical data associated with the one or more digital parking stations. In another embodiment, the request for parking data is generated as a result of the parking operator logging into a web interface and selecting a particular view of parking data (for the one or more parking lots or garages managed by the parking operator) from the web interface. For example, the request can be generated as a result of the parking operator selecting a view such as shown by example snapshots 400 and 500 described above.

Subsequently, example process 700 proceeds to step 708, which includes generating the parking data from the aggregated parking data, in response to the request. In an embodiment, the parking data is generated by filtering the aggregated parking data, responsive to the parking data request. For example, the filtering can include filtering the aggregated parking data by parking operator (e.g., retrieving only data associated with the parking operator sending the request), by digital parking station (e.g., retrieving parking station health data for a particular digital parking station or to enable a selected view of parking information), by parking stall (e.g., retrieving parking stall data for a particular parking stall or to enable a selected view of parking information), etc.

Finally, example process 700 terminates in step 710, which includes sending the parking data and associated views for displaying the parking data to the parking operator. In another embodiment, where the enabled parking management system (e.g., parking management system 110) is not cloud-based, the views are loaded at installation time at the parking management system, and therefore do not require to be sent with the parking data in step 710.

FIG. 8 is an example process 800 for facilitating locating parking space according to an embodiment. Example process 800 is provided for the purpose of illustration only and is not limiting of embodiments. Example process 800 can be performed by parking operations system 102, for example, to enable a parking locating application, such as mobile application 114.

As shown in FIG. 8, example process 800 begins in step 802, which includes receiving parking vendor data from a plurality of parking meter vendors. In an embodiment, the parking vendor data includes at least one of parking station health data and parking stall data. The parking station health data includes data regarding an operational status/health of digital parking stations (e.g., online/offline, error state/type of error, battery level, if applicable, printer paper level, printer ink level, local time, etc.) managed by the parking meter vendor. The parking stall data includes data regarding the status of one or more parking stalls managed by the parking meter vendor. In an embodiment, the parking stall data for a particular parking stall includes a parking stall number, one or more digital parking stations associated with the parking stall, and a parking expiration time of the parking stall. In another embodiment, the parking vendor data includes additional parking data provided by the parking meter vendor, such as parking rates, parking hours, maximum parking time, and enforcement hours associated with the digital parking stations (or more specifically the parking lots/garages) managed by the parking meter vendor. In an embodiment, at least one of the plurality of parking meter vendors provides an Open API, and step 702 further includes accessing, using the Open API, a service of the parking meter vendor to receive the parking vendor data.

Subsequently, example process 800 proceeds to step 804, which includes processing the received parking vendor data to generate aggregated parking data. In an embodiment, step 802 further includes processing the parking station health data to generate aggregated parking station health data representative of an operational status of a plurality of digital parking stations and processing the parking stall data to generate aggregated parking stall data representative of the status of a plurality of parking stalls. The aggregated parking station health data includes the health data of a plurality of digital parking stations, which may be located in various parking lots/garages and/or managed by various parking meter vendors. The aggregated parking stall data includes parking stall for a plurality of parking stalls, which may be distributed across various parking lets/garages: and/or managed by various parking meter vendors.

Then, in step 806, example process 800 includes receiving a parking location request from an application. In an embodiment, the application can be a mobile application configured to operate on a smart phone or a tablet. In an embodiment, the parking location request can include an address, GNSS coordinates, the name of a place (e.g., Times Square), or any other location identifying information. Additionally, the parking location request can include parking preferences such as a desired maximum parking time, a desired parking rate, desired characteristics of the parking (e.g., open lot, gated lot, garage, etc.), and a maximum distance from the desired parking location.

Subsequently, example process 800 proceeds to step 808, which includes processing the aggregated parking data, using the parking location request, to generate probable parking locations. The probable parking locations include parking options that match or substantially match the desired location and any parking preferences provided in the parking location request. In an embodiment, a probable parking location can include, for example, an address of the parking lot or garage, a number of currently open spaces in the parking lot or garage, an hourly parking rate, a maximum parking time, etc. Example process 800 terminates in step 810, which includes sending the probable parking locations to the application.

FIG. 9 is an example process 900 for facilitating parking enforcement according to an embodiment. Example process 900 is provided for the purpose of illustration only and is not limiting of embodiments. Example process 900 can be performed by a parking operator using parking management system 110, for example. The parking operator can manage one or more parking lots of garages using example process 900.

As shown in FIG. 9, example process 900 begins in step 902, which includes sending a request for parking data to a parking operations service. In an embodiment, the request for parking data includes a parking information request for one or more digital parking stations and associated parking stalls managed by the parking operator, including, for example, space availability data, parking station health data and maintenance data, expired parking data, and historical data associated with the one or more digital parking stations. In another embodiment, the request for parking data is generated as a result of the parking operator logging into a web interface (e.g., via parking management system 110) and selecting a particular view of the parking data (for the one or more parking lots or garages managed by the parking operator) from the web interface. For example, the request can be generated as a result of the parking operator selecting a view such as shown by example snapshots 400 and 500 described above.

Subsequently, example process 900 proceeds to step 904, which includes receiving the parking data and associated views for displaying parking data from the parking operations service. In an embodiment, the parking data includes health data representative of an operational status of a plurality of digital parking stations managed by the parking operator, parking stall data representative of the status of a plurality of parking stalls managed by the parking operator, and street ambassador data representative of geographic availability of street ambassadors associated with the parking operator. In another embodiment, the parking stall data farther includes space availability data representative of available parking space in the one or more parking lots or garages managed by the parking operator. In an embodiment, the street ambassador data further provides GNSS tracking data of the street ambassadors such that they can be located on a geospatial map. Additionally, the street ambassador data can also indicate which street ambassadors are on duty/off duty. In a further embodiment, the parking data can include historical health and/or parking stall data. The historical health data can be used to assess the general functioning of digital parking stations and/or to determine future maintenance needs of the digital parking stations, for example. The historical parking stall data can be used to assess the general use/occupancy of a particular parking lot or garage, for example.

Then, in step 906, process 900 includes displaying the parking data using the associated views. In an embodiment, the parking data is displayed using the associated views in a web interface or a cloud-based dashboard as described above. The display of parking data can include various textual (e.g., listings) and/or visual (geospatial maps) representations of parking data. For example, the parking data is displayed as illustrated by example snapshots 400 and 500 described above.

Subsequently, in step 908, example process 900 includes identifying a parking abnormality from the display of the parking data. Step 908 can be performed by a human operator inspecting the display of the parking data or in an automated fashion based on predetermined parameters configurable to generate flags/alerts for particular parking abnormalities. The parking abnormality can include a malfunctioning digital parking station, an expired parking stall, and a soon-to-expire parking stall, for example.

Then, example process 900 proceeds to step 910, which includes identifying a street ambassador in proximity to the identified parking abnormality from the parking data. Step 910 can be performed by a human operator inspecting the display of the parking data or in an automated fashion based on predetermined parameters configurable to identify street ambassadors within a certain distance from an identified parking abnormality.

Finally, example process 900 terminates in step 912, which includes sending a message regarding the parking abnormality to the identified street ambassador. Step 912 can be performed by a human operator or in an automated fashion upon the identification of parking abnormality and a street ambassador in proximity to the identified parking abnormality. In an embodiment, step 912 includes sending the message to the parking operations service for storage for the identified street ambassador to retrieve at a later time.

Embodiments of the present disclosure can be implemented in hardware, software or as a combination of software and hardware. Consequently, embodiments of the disclosure may be implemented in the environment of a computer system or other processing system. An example computer system 1000, which can be used to implement embodiments, is shown in FIG. 10. Embodiments described in FIGS. 1-6 above may execute on one or more computer systems 1000. Furthermore, each of the steps of the processes depicted in FIGS. 7-9 can be implemented on one or more computer systems 1000.

As shown in FIG. 10, computer system 1000 includes one or more processors, such as processor 1004. Processor 1004 can be a special purpose or a general purpose digital signal processor. Processor 1004 is connected to a communication infrastructure 1002 (for example, a bus or network). Various software implementations are described in terms of this exemplary computer system. After reading this description, it will become apparent to a person skilled in the relevant art(s) how to implement the disclosure using other computer systems and/or computer architectures.

Computer system 1000 also includes a main memory 1006, preferably random access memory (RAM), and may also include a secondary memory 1008. Secondary memory 1008 may include, for example, a hard disk drive 1010 and/or a removable storage drive 1012, representing a floppy disk drive, a magnetic tape drive, an optical disk drive, or the like. Removable storage drive 1012 reads from and/or writes to a removable storage unit 1016 in a well-known manner. Removable storage unit 1016 represents a floppy disk, magnetic tape, optical disk, or the like, which is read by and written to by removable storage drive 1012. As will be appreciated by persons skilled in the relevant art(s), removable storage unit 1016 includes a computer usable storage medium having stored therein computer software and/or data.

In alternative implementations, secondary memory 1008 may include other similar means for allowing computer programs or other instructions to be loaded into computer system 1000. Such means may include, for example, a removable storage unit 1018 and an interface 1014. Examples of such means may include a program cartridge and cartridge interface (such as that found in video game devices), a removable memory chip (such as an EPROM, or PROM) and associated socket, a thumb drive and USB port, and other removable storage units 1018 and interfaces 1014 which allow software and data to be transferred from removable storage unit 1018 to computer system. 1000.

Computer system 1000 may also include a communications interface 1020. Communications interface 1020 allows software and data to be transferred between computer system 1000 and external devices. Examples of communications interface 1020 may include a modem, a network interface (such as an Ethernet card), a communications port, a PCMCIA slot and card, etc. Software and data transferred via communications interface 1020 are in the form of signals which may be electronic, electromagnetic, optical, or other signals capable of being received by communications interface 1020. These signals are provided to communications interface 1020 via a communications path 1022. Communications path 1022 carries signals and may be implemented using wire or cable, fiber optics, a phone line, a cellular phone link, an RF link and other communications channels.

As used herein, the terms “computer program medium” and “computer readable medium” are used to generally refer to tangible storage media such as removable storage units 1016 and 1018 or a hard disk installed in hard disk drive 1010. These computer program products are means for providing software to computer system 1000.

Computer programs (also called computer control logic) are stored in main memory 1006 and/or secondary memory 1008. Computer programs may also be received via communications interface 1020. Such computer programs, when executed, enable the computer system 1000 to implement the present disclosure as discussed herein. In particular, the computer programs, when executed, enable processor 1004 to implement the processes of the present disclosure, such as any of the methods described herein. Accordingly, such computer programs represent controllers of the computer system 1000. Where the disclosure is implemented using software, the software may be stored in a computer program product and loaded into computer system 1000 using removable storage drive 1012, interface 1014, or communications interface 1020.

In another embodiment, features of the disclosure are implemented primarily in hardware using, for example, hardware components such as application-specific integrated circuits (ASICs) and gate arrays. Implementation of a hardware state machine so as to perform the functions described herein will also be apparent to persons skilled in the relevant art(s).

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of embodiments of the present disclosure, should not be limited by any of the above-described exemplary embodiments, but should be defined only in accordance with the following claims and their equivalents.

What is claimed is:

1. A computer-implemented method, comprising:
receiving parking vendor data from a plurality of parking meter vendors, wherein the parking vendor data includes at least one of parking station health data and parking stall data;
processing the received parking vendor data to generate aggregated parking data;
receiving a request for parking data from a parking operator;
generating the parking data from the aggregated parking data;
sending the parking data and associated views for displaying the parking data to the parking operator.

2. The computer-implemented method of claim 1, wherein at least one of the plurality of parking meter vendors provides an Open Application Programming Interface (API), and wherein receiving the parking vendor data comprises
accessing, using the Open API, a service of said at least one of the plurality of parking meter vendors to receive the parking vendor data.

3. The computer-implemented method of claim 1, wherein said processing comprises:
processing the parking station health data to generate aggregated parking station health data representative of an operational status of a plurality of digital parking stations; and
processing the parking stall data to generate aggregated parking stall data representative of the status of a plurality of parking stalls.

4. The computer-implemented method of claim 1, wherein receiving the request for parking data from the parking operator comprises:
receiving a parking information request for one or more digital parking stations and associated parking stalls managed by the parking operator.

5. The computer-implemented method of claim 4, wherein the parking information request includes a request for at least one of: space availability data, parking station health data, parking station maintenance data, expired parking data, and historical data associated with the one or more digital parking stations.

6. The computer-implemented method of claim 4, wherein said generating comprises:
filtering the aggregated parking data, responsive to the parking information request, to generate the parking data.

7. The computer-implemented method of claim 1, further comprising:
receiving a first message from a street ambassador associated with the parking operator;
updating the aggregated parking data responsive to the first message; and
pushing the first message to the parking operator.

8. The computer-implemented method of claim 7, further comprising:
receiving a second message from the parking operator;
updating the aggregated parking data responsive to the second message; and
pushing the second message to the street ambassador.

9. The computer-implemented method of claim 1, further comprising:
receiving a parking location request from an application;
processing the aggregated parking data, using the parking location request, to generate probable parking locations; and
sending the probable parking locations to the application.

10. A parking operations system, comprising:
a data extraction and transformation module configured to receive parking vendor data from a plurality of parking meter vendors, wherein the parking vendor data includes at least one of parking station health data and parking stall data, and to process the received parking vendor data to generate aggregated parking data;
a database configured to store the aggregated parking data; and
a web user interface module configured to receive a request for parking data from a parking operator and to send the parking data and associated views for displaying the parking data to the parking operator.

11. The parking operations system of claim 10, wherein at least one of the plurality of parking meter vendors provides an Open Application Programming Interface (API), and wherein the data extraction and transformation module comprises:
at least one virtual machine configured to access, using the Open API, a service of said at least one of the plurality of parking meter vendors to receive the parking vendor data.

12. The parking operations system of claim 11, wherein the at least one virtual machine is implemented using a worker role module.

13. The parking operations system of claim 10, wherein the data extraction and transformation module is further configured to process the parking station health data to generate aggregated parking station health data representative of an operational status of a plurality of digital parking stations; and to process the parking stall data to generate aggregated parking stall data representative of the status of a plurality of parking stalls.

14. The parking operations system of claim 10, wherein the web interface module comprises:
a controller module configured to receive the request for parking data from the parking operator and to send the parking data to the parking operator; and
a view loading module configured to send the associated views for displaying the parking data to the parking operator.

15. The parking operations system of claim 14, wherein the controller module comprises:
a REST and/or SOAP enabled Application Programming Interface (API) configured to communicate with the parking operator; and
a web role module configured to access the database, generate the parking data from the aggregated parking data, and command the view loading module to generate the associated views for displaying the parking data.

16. The parking operations system of claim 10, wherein the request for parking data includes a parking information request for one or more digital parking stations and associated parking stalls managed by the parking operator.

17. The parking operations system of claim 16, wherein the parking information request includes a request for at least one of: space availability data, parking station health data, parking station maintenance data, expired parking data, and historical data associated with the one or more digital parking stations.

18. A method for digital parking enforcement by a parking operator, comprising:
receiving parking data and associated views for displaying the parking data from a parking operations service;
identifying a parking abnormality from the parking data;
identifying a street ambassador in proximity to the identified parking abnormality from the parking data; and
sending a message regarding the parking abnormality to the identified street ambassador.

19. The method of claim 18, wherein the parking data includes health data representative of an operational status of a plurality of digital parking stations managed by the parking operator, parking stall data representative of the status of a plurality of parking stalls managed by the parking operator, and street ambassador data representative of geographic availability of street ambassadors associated with the parking operator.

20. The method of claim 18, wherein the parking abnormality includes at least one of: a malfunctioning digital parking station, an expired parking stall, and a soon-to-expire parking stall.

21. The method of claim 18, wherein sending the message to the identified street ambassador comprises sending the message to the parking operations service for storage for the identified street ambassador.

22. A computer program product comprising a tangible computer useable medium including control logic stored therein, the control logic when executed by one or more processors enables parking assistance according to a method, the method comprising:
receiving parking vendor data from a plurality of parking meter vendors, wherein the parking vendor data includes at least one of parking station health data and parking stall data;
processing the received parking vendor data to generate aggregated parking data;
receiving a parking location request from an application;
processing the aggregated parking data, using the parking location request, to generate probable parking locations; and
sending the probable parking locations to the application.

23. The computer program product of claim 22, further comprising:
selecting an advertisement based on the parking location request; and
sending the advertisement along with the probable parking locations to the application.
